(19) United States
(12) Patent Application Publication
(10) Pub. No.: US 2017/0178131 A1
(43) Pub. Date: Jun. 22, 2017

(54) TRANSACTION SYSTEM AND METHOD

(71) Applicant: EINNOVATIONS HOLDINGS PTE. LTD., SINGAPORE (SG)

(72) Inventors: Jose Benjamin S. FERNANDEZ, Makati City (PH); Alex D. IBASCO, Makati City (PH); Oliver L. UBALDE, Makati City (PH); Richard C. SALCEDO, Makati City (PH); Jose Antonio C. YULO, Makati City (PH); Oliver P. ORNIDO, Makati City (PH)

(73) Assignee: EINNOVATIONS HOLDINGS PTE. LTD., SINGAPORE (SG)

(21) Appl. No.: 15/115,863

(22) PCT Filed: Feb. 4, 2015
(86) PCT No.: PCT/SG2015/050012

§ 371 Date: Aug. 1, 2016

(30) Foreign Application Priority Data
Feb. 4, 2014 (SG) 2014008106
Feb. 24, 2014 (SG) 10201400156Q

(51) Int. Cl. G06Q 20/40; G06Q 20/10; G06Q 20/36

(52) U.S. Cl. CPC G06Q 20/405; G06Q 20/36; G06Q 20/10

(57) ABSTRACT

A transaction system comprising a transaction facilitator operable to receive and process a transaction request from a user device; a transaction channel 5 controller operable to change the state of the transaction channel between a first and a second state; and a fund provider operable to receive processed transaction request and determine if the transaction channel is in the first or second state; and provide or not provide the funds accordingly is disclosed.

### FIELD OF THE INVENTION

The present invention relates to a transaction system and method. The transaction system and method are particularly relevant, but not limited to facilitating secure mobile wallet transactions and will be described in such context.

### BACKGROUND ART

Each document, reference, patent application or patent cited in this text is expressly incorporated herein in their entirety by reference, which means that it should be read and considered by the reader as part of this text. That the document, reference, patent application, or patent cited in this text is not repeated in this text is merely for reasons of conciseness.

The following discussion of the background to the invention is intended to facilitate an understanding of the present invention only. It should be appreciated that the discussion is not an acknowledgement or admission that any of the material referred to was published, known or part of the common general knowledge of the person skilled in the art in any jurisdiction as at the priority date of the invention.

Rapid advancement in the development of mobile devices and related software applications (hereinafter referred to as ‘apps’) has resulted in increasing e-commerce transactions performed because such advancement in technology offers users the convenience of con the go′ transactions as long as any type of connection (GSM, GPRS, 3G, Wi-Fi etc.) can be established to the Internet. In particular, credit card users or fund source owners now enjoy unprecedented electronic transaction, such as electronic shopping experience as they may now choose from a variety of transaction channels/modes instead of the traditional point of sale (POS) or related electronic transfers requiring the use of dedicated end terminals which typically are located only at designated locations where the sale takes place.

The availability of increasing transaction channels/modes inadvertently lead to the increasing occurrences of fraud/security breach, where information of credit card users such as PAN, CVC2, Expiry Date, etc. are exposed due to insecure websites or hacking activity. Despite the efforts of card issuers and acquirer in the financial industry encouraging the implementation of a variety of financial security standards (SSL, EMV Chips and 3D secure) etc., such security standards would secure the transaction channel and/or the transaction device to certain extent but are not an effective fool proof way of preventing scheming, theft and internal fraud. Moreover, not all electronic merchants are mandated to implement those security compliance/standards, and unaware credit card users may inadvertently subject/avail themselves to such ‘insecure’ transaction channels.

As an example, a credit card holder wishes to reserve an airline ticket and thus access an online reservation/booking website. To make payment via credit card for completing the online reservation, standard well-known process is to provide the cardholder information like Card Name, PAN (Primary Account Number or card number), CVC2 and Expiry Date. If these transaction data are not properly protected and obtained or intercepted by an unauthorized entity while the credit card holder is completing the transaction, the unauthorized entity may use the data for other unauthorized payment transaction or may even fabricate a card and use the fabricated card for transaction just like a legitimate card transaction.

To overcome the potential breach in security, prior art transaction systems that provides additional security by allowing a holder of a financial account card, such as a credit card or debit card, to disable and re-enable use of the card by locking and unlocking the card repeatedly has been disclosed. However, such a system adopts an “all or nothing” approach to the security problem in that no transactions at all can be made when the associated card is in the locked state, and the holder has to unlock the card prior to making any transactions.

The system as described in PCT publication WO2010/147559 describes a system and method that allows a user or provider of a ‘smart card’, such as a credit card, to change the state of a transaction channel, in particular allowing a user or provider to ‘lock’ and/or ‘unlock’ certain transaction channels/modes such as web purchasing, point of sale purchasing, etc. with respect to other transaction modes. The system allows a user or provider the flexibility to ‘choose’ the types of transaction channels that may be used to effect transactions. So, for example, a user may decide that, for security reasons, he/she will ‘lock’ his card to prevent the card from being used for web-based purchases, but will leave the card unlocked for traditional point of sale (POS) purchases. If the user's card is stolen, an unauthorized user would not be able to use the card to effect any web-based purchases, thereby providing an extra level of security while according certain level of flexibility.

The system was further improved as described in PCT publication WO 2013/103323 where card issuers are given the option of the locking/unlocking feature.

While the above systems provide a level of flexibility to a user to disable certain transaction channels instead of the whole account, there exist limitations faced by the user in particular when he wishes to make authorized batch payment to online merchants. In particular, batch mode process involves having the merchants transacting with the user(s) where pre-approval of cardholder transaction is made and actual authorization is suspended for a predetermined period. The merchant system then subsequently executes batch authorization payment to reduce its cost of interchange fee charges on clearing and settlement. Such a scenario is however not transparent to a user (cardholder) such that when the cardholder/user unlocks his account to allow transaction via a transaction channel such as internet purchase by thinking that the pre-approved process was really an authorization from their issuing bank. By the time the batch authorization takes place, the cardholder account status is already back to “lock state” (or back to default) which resulted in rejection of transactions at the stage of pre-authorization validation.

The present invention seeks to improve the transaction systems and methods that reduce or prevent the occurrence of transaction fraud to at least some extent while allowing greater flexibility for the user to perform transaction and greater customization of a selective lock/unlock feature.

### SUMMARY OF THE INVENTION

Throughout the specification, unless the context requires otherwise, the word “comprise” or variations such as “comprises” or “comprising”, will be understood to imply the inclusion of a stated integer or group of integers but not the exclusion of any other integer or group of integers.

Furthermore, throughout the specification, unless the context requires otherwise, the word “include” or variations such as “includes” or “including”, will be understood to imply the inclusion of a stated integer or group of integers but not the exclusion of any other integer or group of integers.

In accordance with an aspect of the present invention, there is provided a transaction system comprising:

a transaction facilitator operable to receive and process a transaction request from a user device; a transaction channel controller operable to change the state of the transaction channel between a first and a second state; and a fund provider operable to receive processed transaction request and determine if the transaction channel is in the first or second state; and provide or not provide the funds accordingly.

Preferably, the first state corresponds to a state where the transaction channel is locked and forbidden for any transaction.

Preferably, the default state is the first state.

Preferably, the instruction to change the transaction channel from the first to second state and vice versa is initiated by the user device.

Preferably, the fund provider comprises a user profile database operable to automate the instruction to change the transaction channel from the first to second state and vice versa.

Preferably, the user profile database is operable to capture one or more of the following transaction parameters from the transaction request in order to determine whether the transaction channel should be in the first or second state:—Transaction Datetime stamp; Merchant Category Code; Merchant Name; Merchant Address; Transaction Amount; Country Code; or Currency Code.

Preferably, the user profile database is operable to determine the location of the user device sending the transaction request in order to determine whether the transaction channel should be in the first or second state.

Preferably, the transaction channel is one of the following:—point of sale (POS) terminal; Internet transaction; ATM.

In accordance with a second aspect of the present invention, there is provided a transaction method comprising:

receiving and processing from a transaction facilitator a transaction request from a user device;
receiving from a transaction channel controller a request to change the state of the transaction channel between a first and a second state;
wherein the processed transaction request is successful or not successful depending on whether the transaction channel is in the first or second state.

### BRIEF DESCRIPTION OF THE DRAWINGS

The present invention will now be described, by way of example only, with reference to the accompanying drawings, in which:

FIG. 1 shows a user requesting the change of state of his fund source between a lock and a unlock state via a transaction state controller (Lock/Unlock Controller) according with an embodiment of the invention;

FIG. 2 illustrates a user performing a transaction with the transaction state controller and fund source system;

FIG. 3 illustrates an unauthorized user performing an unauthorized transaction via the Internet while the fund source system is in the lock state;

FIG. 4 illustrates an unauthorized user performing an unauthorized transaction via a Point of Sale terminal while the fund source system is in the lock state;

FIG. 5 shows the transaction system with different transaction channels and/or devices;

FIG. 6 shows the transaction system wherein the transaction state controller comprises an electronic wallet operable to receive and process registration requests;

FIG. 7 illustrates the system of FIG. 6 being used for self-registrations for personalization of the electronic wallet and generation of a personalized transaction medium such as a credit/debit card; and

FIG. 8 illustrates the system of FIG. 6 being used for multiple linking of fund sources.

Other arrangements of the invention are possible and, consequently, the accompanying drawings are not to be understood as superseding the generality of the description of the invention.

### DESCRIPTION OF EMBODIMENTS OF THE INVENTION

In accordance with an embodiment of the invention there is a transaction system 10 comprising a user device 12 operable to send a transaction request 14 via a transaction channel 16. The transaction channel 16 may be chosen from a plurality of transaction channels 16 available to the user at a specific time period. Each transaction channel 16 may be utilized to access one or more transaction accounts belonging to the user.

The system comprises a transaction facilitator 18 operable to receive and process the transaction request 14 from the user device 12. Transaction facilitator 18 may include a web portal, Internet server, a combination of servers (whether distributed or otherwise), to facilitate the processing of the transaction requests in at least one communication protocol. Examples of communication protocol include SMS, mobile app API etc.

In addition, the system 10 comprises a transaction channel controller 20 operable to change the transactional state of the transaction channel 16 and/or transaction device 12 between a first and a second state. It is to be appreciated that for the change of transactional state of the transaction device 12, the change of state from the first state (lock) to the second state (unlock) would have to take place prior to the actual transaction authorization. Upon receipt of a request for change of state of the transaction device 12, the transaction channel controller 20 is operable to pre-authorize the state for the transaction device 12 prior to any transaction. Otherwise, if the transaction device 12 is not unlocked before any transaction, any transaction(s) will be declined. The changing of the lock/unlock status is not prescribed to be synchronous to the actual transaction request to avoid time-out scenarios.

The system 10 also includes a fund provider or fund source 22 operable to receive processed transaction request and determine if the transaction channel is in the first or second state; and notify the user device 12 accordingly.

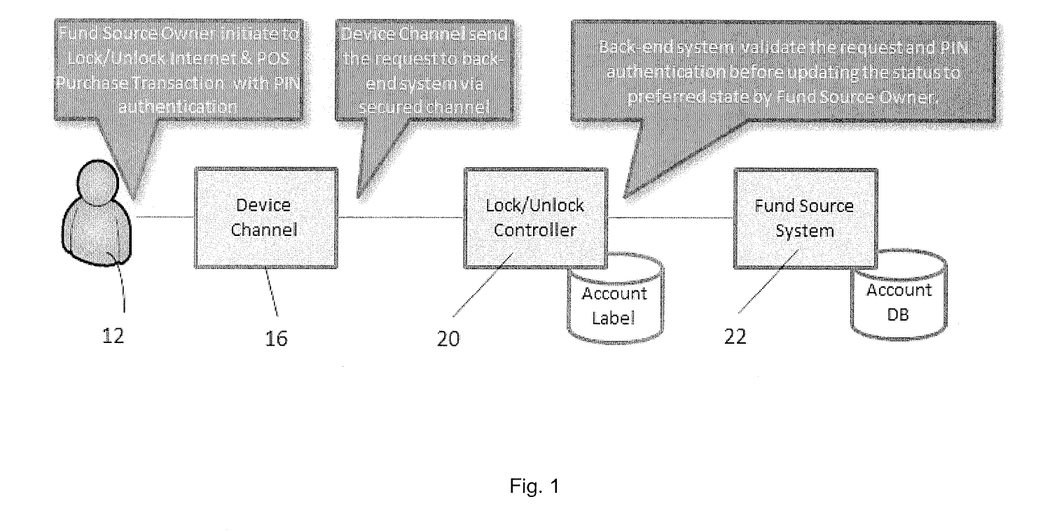

Referring to FIG. 1, the user device 12 sends a state change request to transaction channel controller 20 (Lock/Unlock controller) to change the transaction channel 16 from a first state (lock) to a second state (unlock), and vice versa. It is to be appreciated that the terms ‘first’ and ‘second’ are used for illustrating the examples, and may be interchangeable.

The transaction device 12 may be is a personal computer, smart phone or any device capable of displaying and interacting with a transaction portal 18 that may include a payment portal. The user interface for displaying and interacting with the payment portal is typically in the form of a website of a payment gateway of a merchant. The website is accessible by a user via a web browser of a personal computer 12 operably connected to be in data communication with other components of the transaction system 10 via a communication network comprising a plurality of transaction channels 16. The user interface for displaying and interacting with the transaction portal 18 may also be in the form of a dedicated software application colloquially known as an ‘app’. The plurality of transaction channels 16 include (but is not limited to) 3G/4G, Wi-Fi connection to the Internet; direct LAN connection to the Internet; point of sale (POS) terminal; or Automated Teller Machines (ATM). It is to be appreciated that amongst the plurality of transaction channels 16, at least one transaction channel 16 may be less secured relative to another transaction channel 16. It is further to be appreciated that each transaction channel can be locked/unlocked individually without the transaction account being locked/unlocked.

The merchant offers good and services for sale, which may be purchased electronically (‘on-line’) by a customer accessing the website.

The use and operation of the Internet, computers and servers using software applications and payment portals are well known to persons skilled in the art and need not be described in any further detail herein except as is relevant to the present invention.

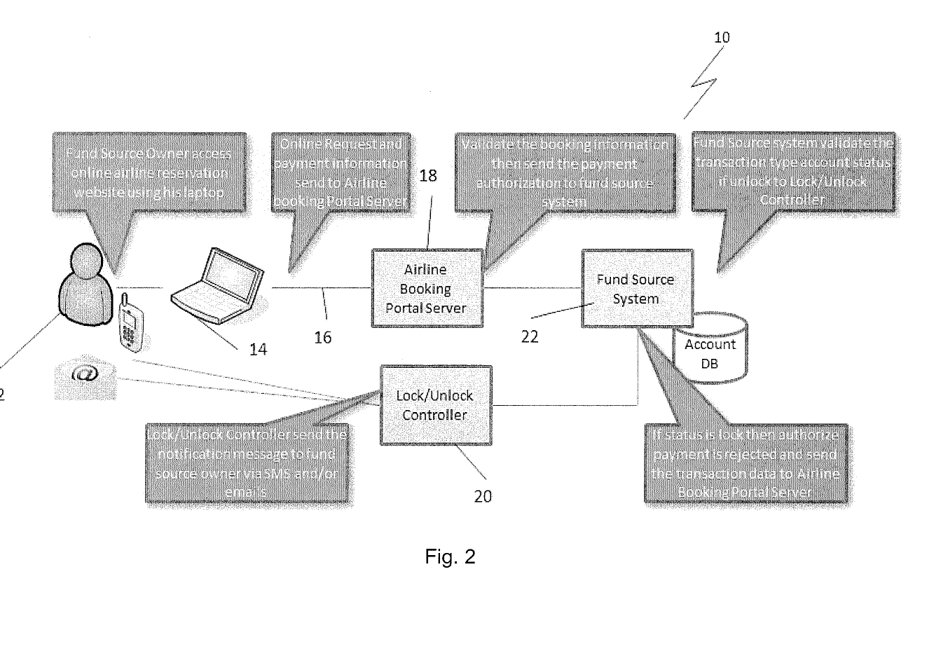

In the embodiment described and with reference to both FIG. 1 and FIG. 2, a user of transaction device 12 is the fund source owner and wishes to reserve as well as make payment for one or more air tickets. Before making any reservation, he accesses the transaction mode/channel controller 20 (via an authentication procedure) to enable (unlock) the particular transaction channel 16, in this case Internet transaction channel for access to his source fund 22. The authentication procedure is in the form of (but is not limited to) a PIN authentication, for example.

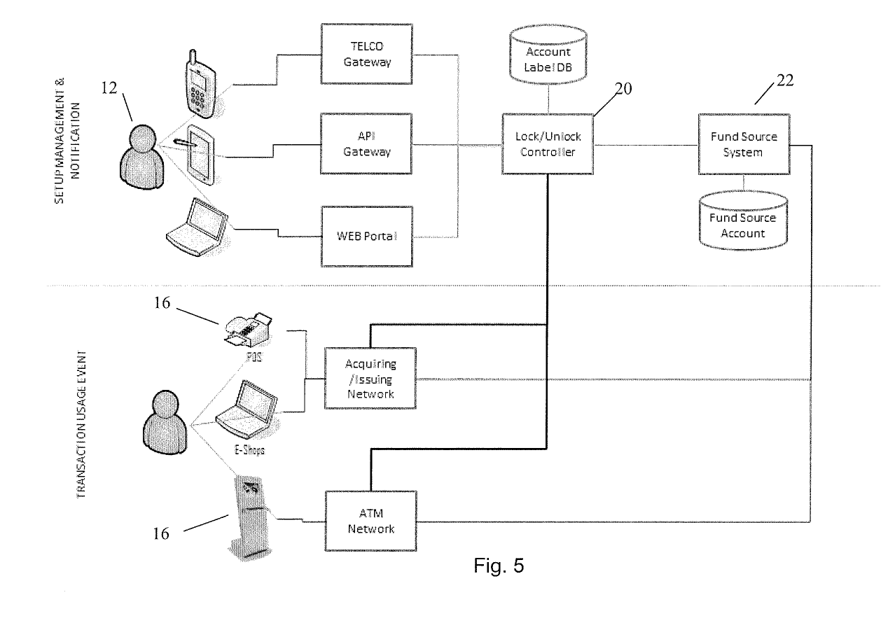

FIG. 5 illustrates how a user may enable a transaction channel or mode before performing any transactions. The user may access or log in to the lock/unlock controller 20 via a telecommunications gateway, API gateway and/or a web portal. Once logged in, the user will then select one or more transaction channels to be enabled for subsequent transactions. It is to be appreciated that these transaction channels are by default in a ‘disabled’ mode. In the process of any transaction, transaction requests would also be sent to the lock/unlock controller 20 for verification of whether the particular transaction channel has been ‘enabled’ or ‘unlocked’ for the transaction to proceed.

In an example, the transaction channel 16 enabled by the user is ‘Internet’. Once Internet transaction channel is enabled, the user 12 may then access the airline reservation website/portal for performing his necessary reservation. Once the reservation is made, the user would be prompted to make payment by choosing his transaction payment preference. If he chooses online electronic payment mode, he will be prompted to key in his preferred credit card number and details such as Card Name, PAN (Primary Account Number or card number), CVC2 and Expiry Date.

Upon keying in the transaction details, the airline reservation website will access the fund source system 22, such as a credit card or bank account, for example, MasterCard™ Worldwide, where the user has an account with.

As the transaction channel ‘Internet transaction’ has earlier been enabled, payment would successfully be debited from the fund source 22 once the credit card number and details are verified to be correct. The successful payment notification will be sent to transaction channel controller 20. The transaction channel controller 20 will then send an electronic transaction receipt in the form of an electronic data such as SMS or an email to notify the user of the transaction device 12 of the successful transaction. Upon successful payment notification, the transaction is then deemed completed.

If ‘Internet transaction’ was not previously enabled, then the fund source 22 rejects the payment request even though the provided credit card details may be valid. An ‘unsuccessful’ notification will then be sent to the transaction channel controller 20. The transaction channel controller 20 will send a SMS or email to the transaction device 12 notifying the user of the unsuccessful transaction.

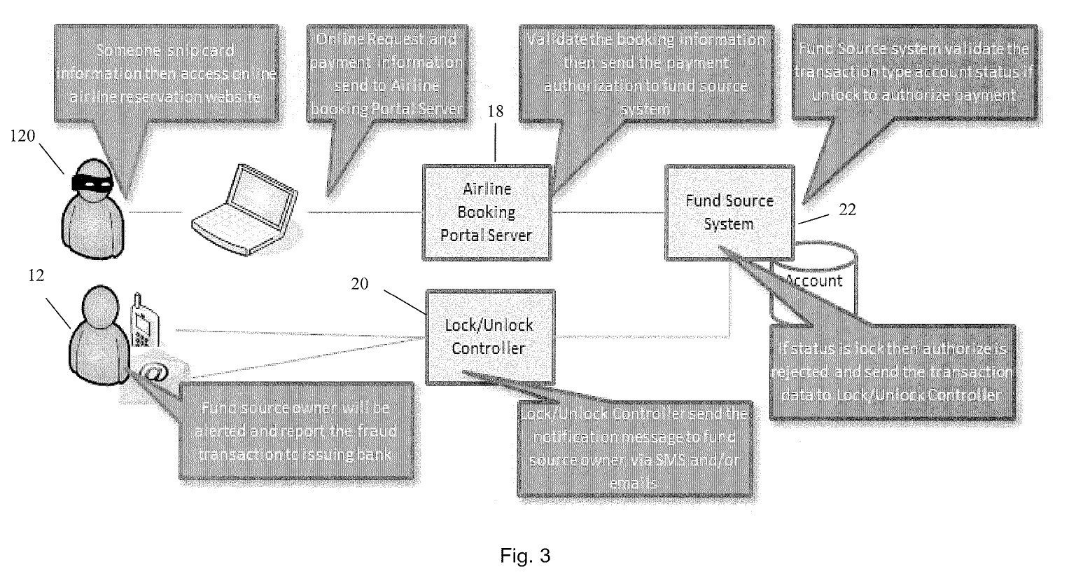

FIG. 3 illustrates the scenario where an unauthorized person 120 snipes credit card information of the user of the transaction device 12 and attempts to use the credit card information to make unauthorized airline reservations. As ‘Internet transaction’ as a mode of transaction to access the fund source 22 was not previously enabled by the user, the fund source will reject any payment request sent to it, regardless of the validity of the credit card details provided.

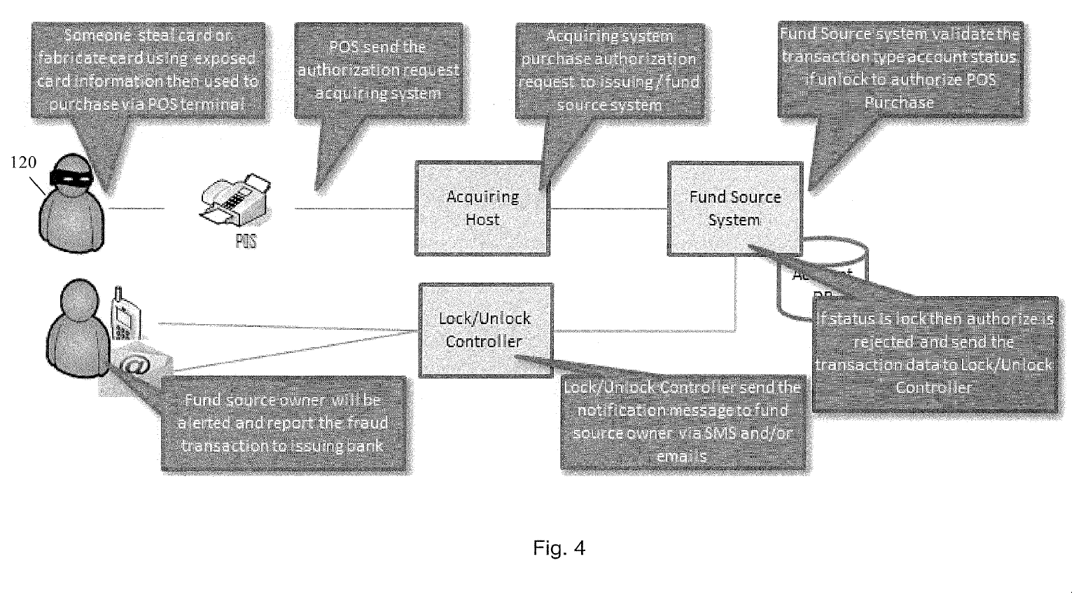

FIG. 4 illustrates the scenario where an unauthorized person 120 snipes credit card information of the user of the transaction device 12 and fabricate a fake credit card based on the sniped credit card information. The unauthorized person then attempts to use the credit card information to make unauthorized purchase with a merchant at a physical store using a Point of Sale terminal 16. If ‘OS transaction’ as a mode of transaction to access the fund source 22 was not previously enabled by the user, the fund source will reject any payment request sent to it, regardless of the validity of the credit card details provided.

In another embodiment, the fund source 22 is coupled with one or more user profile databases. The user profile databases may include location based services and are used to capture usage patterns, locations, favourite merchants, transaction amount, countries where most transaction take place, currency of transactions etc. The captured user profile data may be used to automate the change of transaction states between clock′ and ‘unlock’ without the need for a user's manual input provided the user chooses to effect such a feature known as ‘enhanced lock-unlock’. It is to be appreciated that the enhanced lock-unlock feature may be used in conjunction with the manual lock/unlock or as an alternative. In the latter, where there is a conflict between manual and automatic instructions to lock/unlock the fund source, the manual instruction prevails and the automatic lock/unlock instruction is overrided.

Referring to FIG. 1, the enhanced lock-unlock feature may be sent via one of the request to ‘turn on’ the automatic lock-unlock feature. The enhanced lock-unlock feature is customized for a user/fund source owner by taking into account the ‘risk appetite’ of the user/fund source owner. The customization process is described as follows.

Prior to activating the enhanced lock unlock feature, a user will be prompted by the fund source system 22 to input the number of transaction parameters he wishes to use for customizing the clock-unlock′ feature. The lower the risk appetite of the user, the more transaction parameters used for customization. For verification, the user may be prompted to enter a password, such as a mobile personal identification number (mPIN) for submission to the fund source 22. The mPIN may also be requested before the user logs in to the transaction portal 18.

Using an example, a user may be presented a list of transaction parameters as a basis for an automatic lock if there is a match for one or more of the value/parameters associated with a transaction request. The parameters include information and data relating to the date, time and location of transaction, merchant information, transaction amount/value, geographical location of user, currency used for transaction, etc. The transaction parameters will be compared with a set of rule-base and logic for determination of whether a transaction channel should be locked or unlocked. Examples of rules and logic include:—
i. Transaction date time stamp—for prohibiting transactions if the transactions takes place at certain date and time (for example, when the user is overseas/or during hours when the probability of the user making a purchase is low)
ii. Merchant category code—for prohibiting transactions with merchants belonging to certain categories which the user has a low probability of making any purchase
iii. Merchant name—for prohibiting transactions with blacklisted merchants
iv. Merchant address—for prohibiting transactions with blacklisted merchants
v. Transaction amount—for prohibiting transactions above a certain upper limit
vi. Country code—for prohibiting transactions in certain countries
vii. Currency code—for prohibiting transactions made in certain currencies

In addition to the defined transaction parameters, location based services (LBS) may be used to enable the risk alert management for the auto-lock feature. An example of using LBS to enable risk alert management is when a user does an ATM Withdrawal in location A (e.g. Singapore) and within a short duration (e.g. a few seconds later) another ATM withdrawal from the same account takes place in location B (e.g. New York). That is a physical limitation of the same person being in two places at the same time and a rule base feature of Risk Alert Management incorporated in the system which is operable to trigger an Auto-lock of the affected account and a notification to the account holder of the declined transaction.

The above LBS based risk alert management rule activation is applicable for face-to-face type transactions where physical presence is required, for example for ATM and POS transactions. In addition, the notification feature to account holder as mentioned above is a unique capability of the system that is much appreciated by the end users, because in some usual cases, declined transactions are not accompanied with such notifications. Such declined transactions may cause problems to the end user who may not know why the transaction has been declined or if a fraud has been detected.

Compared to the current auto-lock facility which is based on the global system settings of minute interval and triggered unlock timestamp, the customization of the clock-unlock′ feature provides a ‘fine-tune’ adjustments depending on users' preference and are not limited by a predetermined period of time as disclosed in PCT publication WO2010/147559.

The described embodiment affords the flexibility for authorization of batch payment to third party merchants, such as online merchants for example if the merchant name and address are not in the blacklist.

To address limitations associated with batch mode processing by merchants, this system, known as the enhanced lock-unlock system, introduces granular options based on the described rules and logic to cardholder to specify and enable certain transaction channels 16 like web-online, POS, ATM, etc. with additional feature to enable per transaction channel 16 white-listed option such as the combination of merchant name, merchant category code, merchant location, etc. This way, the cardholder will only allow any unexpected batch authorization payment executed by the whitelisted merchants (if enabled) and those merchants that are not fall under the backlisted merchants (always enabled but depended on the specified list).

The use and operation of transactions facilitated by credit card companies, such as MasterCard™ Worldwide is well known to persons skilled in the art and need not be described in any further detail herein except as is relevant to the present invention. Mechanisms and elements required to implement the ‘lock’ and ‘unlock’ such as specific processors, Unicard Gateway, Acquirer/Issuer system are found in PCT publication WO2010/147559 and the details of which are incorporated herein by reference.

In another embodiment, the system may incorporate the further feature where card issuers are given the option of locking/unlocking as described in PCT publication WO 2013/103323. The feature as disclosed may be used in combination or in conjunction with the enhanced lock/unlock feature.

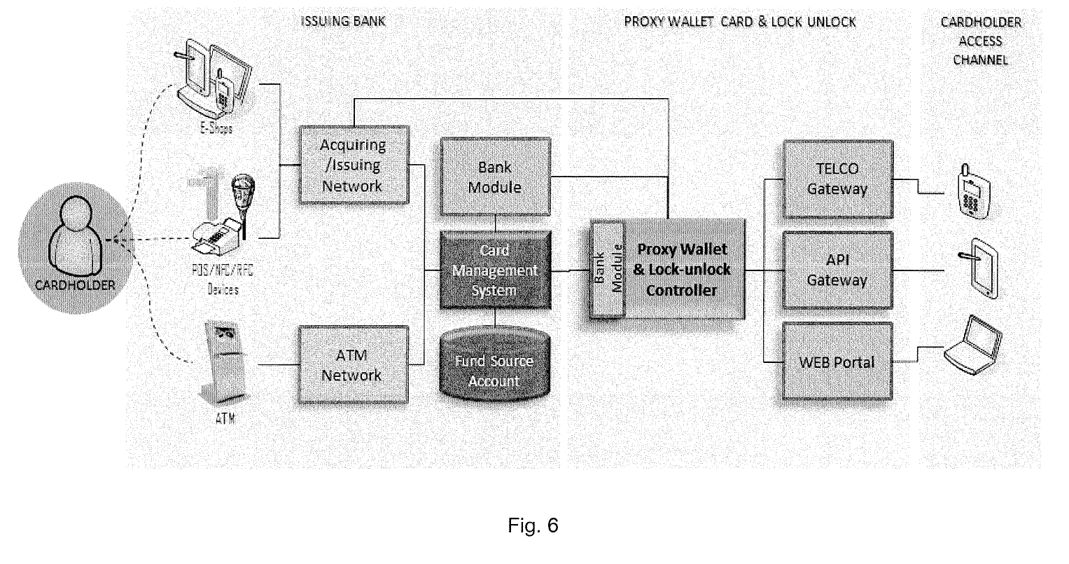

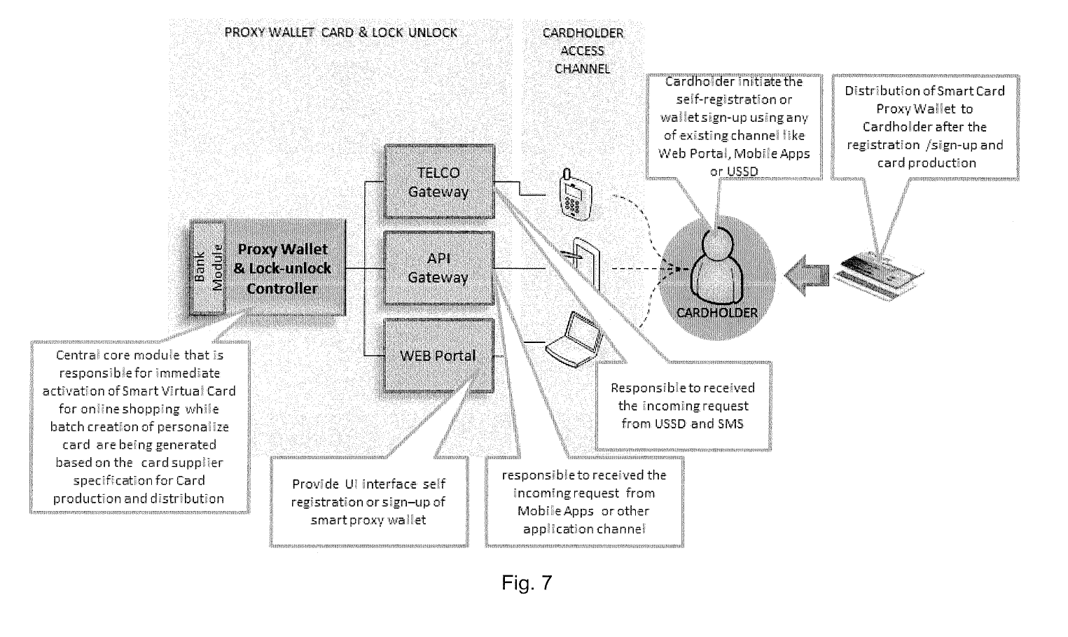

In accordance with another embodiment of the invention and with reference to FIG. 6, wherein like numerals reference like parts, the lock-unlock controller 20 is improvised to include a Proxy Wallet 200 service. The proxy wallet 200 is suited to issue physical transaction cards (e.g. credit or debit cards) that is capable for Point of Sale, Near Field Communication (NFC) and Radio Frequency Communication (RFC) devices for Face to face (F2F) transaction. A user 12 of a communication network, such as a telecommunications network may register for proxy wallet 200 service by initiating a sign-up via any transaction channel 16 such as Web portal, mobile apps, USSD, ATM transaction etc. as illustrated in FIG. 7.

As shown in FIG. 7, the proxy wallet 200 comprises a central core module that is adapted for immediate activation of physical transaction cards such as smart virtual card for performing certain types of transaction (example online electronic shopping). Batch creation of personalized cards is generated based on card supplier specification for production and distribution. A user 12 may initiate self-registration or wallet sign-up using any existing communication channel via the telecommunications network gateway, an API gateway, or a web portal. The telecommunications gateway is arranged to receive incoming user registration requests in the form of USSD or SMS. The API gateway is arranged to receive incoming user registration requests from mobile apps or other application channel (example email), and the web portal is arranged to provide necessary user interface for self-registration or sign-up of the proxy wallet service. Once registration is completed and verified, the physical card, such as a credit or debit card with smart capabilities will then be sent to the user 12.

The sign up and registration capability allows a user to personalize the proxy wallet card generated and define a security PIN authentication. It also allows a user to register basic information as compliance for KYC (know-your-customer) and compliance with regulatory requirement such as the Anti-Money Laundering Act (AMLA) that requires certain level of declaration and transparency.

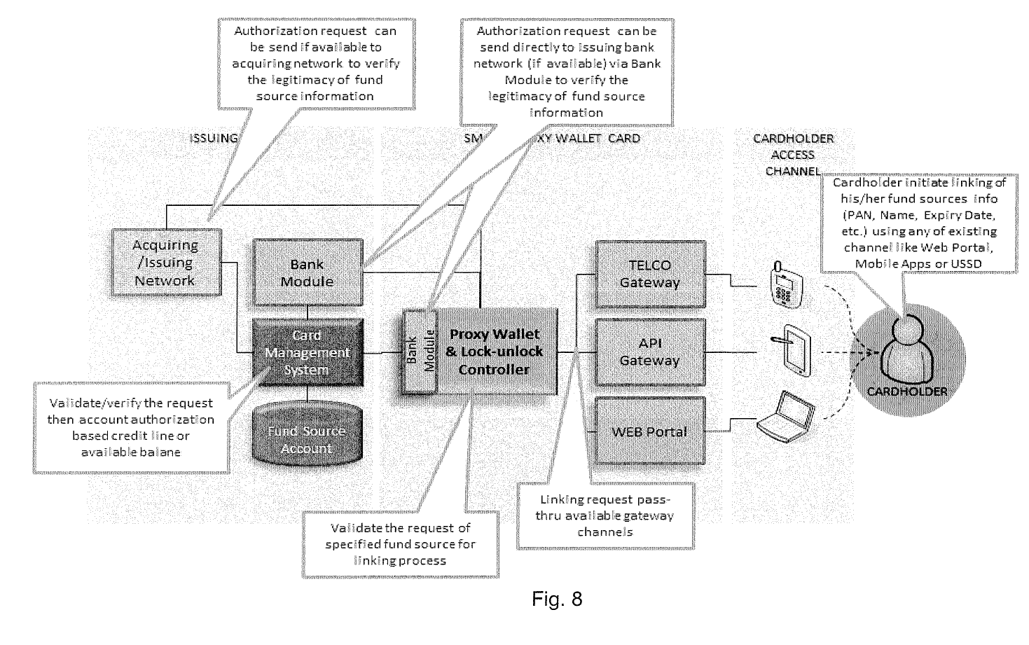

In another embodiment, if the card user has multiple fund sources, he may link his various fund sources as illustrated in FIG. 8. The multiple linking of fund sources (via an authentication protocol, such as the open standard to authorization OAuth protocol verification process if available) during sign-up and/or linking process includes white-label cards with available commercial integration to a financial suite system, such as an e-Money Financial Suite (eFS) eco-system. The Proxy wallet owner can select the default/hierarchy fund source for authorization process. As illustrated in FIG. 8, the linking requests may be sent through the telecommunications gateway, API gateway and/or the web portal. The linking request comprises information associated with the fund source, name, expiry date or time for using any existing channels.

Upon receiving the linking request from the user 12, the proxy wallet and lock/unlock controller 20 validates the same and sends an authorization request to the issuing bank network (if available) via a bank module 21 to verify the legitimacy of the fund source information. Alternatively or in conjunction, the authorization request can also be sent to an acquiring network to verify the legitimacy of fund source information. Upon receipt of the authorization request, the bank module 21 or acquiring/issue network will then send the relevant information for verifying/validating the authorization request and determine the credit line or available balance.

In addition to the multiple linking of fund sources, the user 12 may link all his identifications used for different fund sources via a Multiple Linking of Identification feature. This multiple linking feature links the different or associated identification of cardholder (as the proxy wallet owner) for instant pre-authentication and the acquiring of payment authorization process. This different identification used may include Mobile Number, Email Account, Social-media Account, Government-ID, Plate-number, Transponder ID, Biometric-Scan Data, NFC device ID/sticker, including those identifications that can be utilized for association with specific Merchant or Biller Account.

For instance, if the proxy wallet 200 owner is a regular customer of a particular online shopping facility such as AMAZON™ e-shopping, then he/she can register his log-in account such that upon check-out and he chooses the system acquiring service for payment, the system will automatically detect the corresponding Proxy Wallet 200 Card since the log-in credential from AMAZON™ was already registered as one of wallet owner's ID.

Either or both of the following security features may be utilized for accessing and transacting with the proxy wallet 200.
Single PIN Authentication—this capability feature provide single PIN authentication not only for online transaction but also for card presence transaction devices that requires secure PIN entry.
Permeability Transaction Security—this feature provide an additional security layer to proxy wallet card by accessing user-defined security configuration to allow or restrict specific channel or transaction scenario for financial transaction. This feature uses the combination of account lock-unlock status, available parameters in transactions request (like PAN, Merchant Code, Merchant Name, Currency code, Country code, threshold Amount, Datetime, etc), specified/default fund source (for charging) and Card holders ID's which are all linked and/or associated to Proxy Wallet Card.

In addition to the verification function as described, the Cardholder Management Module is also a capability feature which provide self-care User-Interface for a user to allow the following
Fund source management such as linking, delinking, amount limits per transaction, aggregated transaction limits, account lock-unlock status, including other obvious feature for fund source management
ID Management such as linking, delinking, amount limits per transaction, aggregated transaction limits, account lock-unlock status, including other obvious feature for fund source management
Quick Transaction Search to verify and validate the details of authorized transaction
Online Transaction Statement to retrieved and view statement of account history per fund sources associated or linked to Smart Wallet Proxy Card
Summary of history transaction to provide reports of usage graphs patterns
Security PIN Management such as change PIN and PIN Reset

The Bank Module may include a capability feature to provide standard API (pre-activation & activation, check lock-unlock status, transaction notification via SMS, Apps, email, etc) gateway for easy integration with participating issuing banks partner who are more comfortable for direct integration instead of usual acquiring channel. The bank module can be deployed as part of Proxy Wallet Lock-unlock Control or co-located with bankcard management system (just like MIP of Mastercard™) to provide close-loop and reliable network integration.

The various embodiments described above involve certain level of integration process such as the re-routing of transaction channels to the lock-unlock controller module, rule modification of the card management system; and the activation/linking with the user device 12 via transaction channels such as SMS, STK, Mobile-Apps, and Web-Portal. The embodiments above may be further improved by having a combination of hardware and software to:—
manage, monitor and maintain different fund sources account; such as remembering different PIN security of each fund source;
manage and maintain different identification information that is required during the pre-authentication process like login-credentials which can also be used for pre-authorization.

In addition, the above embodiments may be further improved by having a simpler and “seamless” integration options with issuer banks or fund source system.

The proxy wallet 200 service is advantageous in that it provides a physical Card as proxy wallet based on generation of Pseudo PAN for linkage of different fund sources. The proxy wallet 200 also provides a single PIN for pre-authorization security process. This will address the difficulties of managing and maintaining different fund sources account and difficulties to remember different PIN security of each fund sources.

The proxy wallet 200 may be utilized for the multiple Linking of card holders (Proxy wallet owner's) identify (ID) to address the difficulties of managing and maintaining different identification information that is required during the pre-authentication process such as Mobile Number, Email Account, Social-media Account, Government-ID, Plate-number, Transponder ID, Biometric-Scan Data, NFC device ID/sticker, including those ID's that can associate to specific Merchant or Biller Account for online payment or purchase transaction.

The invention offers alternative integration using bank module for direction integration with issuing bank partners.

The invention also addresses the limitation of Paypal proxy virtual account that is not applicable for POS, NFC and RCF face-to-face (F2F) transaction and limited for safe online shopping only.

It is to be understood that the above embodiments have been provided only by way of exemplification of this invention, and that further modifications and improvements thereto would be apparent to persons skilled in the relevant art and as such are deemed to fall within the broad scope and ambit of the present invention described, in particular:—
The capability to lock/unlock accessibility to the fund source may be extended to the transaction device 12 in addition to the transaction channels.
The account status for each user may be stored in an account database in data communication and accessible by the lock/unlock controller 20.
In addition to the notification of unsuccessful transaction to the lock/unlock controller 20, the notification may also be sent to the transaction facilitator/portal such as the air tickets booking/reservation web portal.
Notifications sent to the consumer may include, but is not limited to:—new registrations; Unregistration; Lock by Mobile Update; Suspicious Transaction Alerts; other alerts that can be requested by fund source; MPIN validation
Instead of configuring the transaction parameters for purpose of auto lock or unlock at the fund source, the configuration may be performed at the lock/unlock controller 20.

It should be further appreciated by the person skilled in the art that variations and combinations of features described above, not being alternatives or substitutes, may be combined to form yet further embodiments falling within the intended scope of the invention.

1. A transaction system comprising
a transaction facilitator operable to provide transaction interface for a user to create a transaction request relating to a transaction account;
a transaction channel controller operable to receive a state change request to change the state of a transaction channel associated with the transaction request between a first and a second state and output the state of the transaction channel when queried; and
a fund provider operable to receive the transaction request relating to the transaction account, query the transaction channel controller on the state of the transaction channel and determine whether to provide or not provide funds from the transaction account accordingly;
wherein the state of the transaction channel is automatically chanced based on profile data of the user without the user's input.

2. The transaction system according to claim 1, wherein the state change request to change the transaction channel between the first and the second state is provided in a manual or an automatic mode; and wherein in the automatic mode the fund provider is in data communication with a user profile database, the user profile database comprises a plurality of transaction parameters for customization based on risk appetite.

3. The transaction system according to claim 2, wherein the first state corresponds to a state where the transaction channel is locked and forbidden for any transaction.

4. The transaction system according to claim 2, wherein a default state is the first state.

5. The transaction system according to claim 2, wherein the manual mode, an instruction to change the state of the at least one transaction channel associated with the transaction between the first to second state and vice versa is initiated by the user.

6. The transaction system according to claim 2, wherein the user profile database is operable to prompt the user to input a pre-determined number of transaction parameters for customizing the automation of an instruction to change the transaction channel from the first to second state and vice versa.

7. The transaction system according to claim 2, wherein the user profile database is operable to retrieve one or more of the following transaction parameters from the transaction request in order to determine whether the transaction channel should be in the first or second state:—location of transaction, merchant information, transaction amount/value, geographical location of user, and/or currency used for transaction.

8. The transaction system according to claim 2, wherein the user profile database is operable to determine a location of a user device sending the transaction request in order to determine whether the transaction channel should be in the first or second state.

9. The transaction system according to claim 2, wherein the user profile database is operable to capture the profile data of the user and provide the state change request by comparing the transaction request to the profile data.

10. The transaction system according to claim 9, wherein the profile data relate to at least one of the following: usage patterns, locations, favourite merchants, transaction amounts, countries and currencies.

11. A transaction method comprising the steps of:
providing to a user via a transaction facilitator, a transaction interface for the user to create a transaction request relating to a transaction account;
receiving via a transaction channel controller, a state change request to change the state of at least one transaction channel associated with the transaction request between a first and a second state and output the state of the transaction channel when queried;
receiving at a fund provider the transaction request and querying the state of the transaction channel; and
determining whether to provide or not complete the transaction request based on the received transaction request and state of transaction channel;
wherein the state of the transaction channel is automatically changed based on profile data of the user without the user's manual input.

12. The transaction method according to claim 11, wherein the state change request to change the state of at least one transaction channel between the first and the second state is provided in a manual or an automatic mode; and wherein in the automatic mode the fund provider is in data communication with a user profile database, the user profile database comprises a plurality of transaction parameters for customization based on risk appetite.

13. The transaction method according to claim 12, wherein the first state corresponds to a state where the transaction channel is locked and forbidden for any transaction.

14. The transaction method according to claim 12, wherein a default state is the first state.

15. The transaction method according to claim 12, further comprising the step of automating an instruction to change the transaction channel from the first to second state and vice versa.

16. The transaction method according to claim 12, further comprising the step of prompting the user to input a pre-determined number of transaction parameters for customizing the automation of an instruction to change the transaction channel from the first to second state and vice versa.

17. The transaction method according to claim 12, further including the step of retrieving one or more of the following transaction parameters from the received transaction request in order to determine whether the transaction channel should be in the first or second state:—location of transaction, merchant information, transaction amount/value, geographical location of user, and/or currency used for transaction.

18. The transaction method according to claim 12 further comprising the step of determining a location of the user who created the transaction request in order to determine whether the transaction channel should be in the first or second state.

19. The transaction method according to claim 12, wherein the user profile database is operable to capture the profile data of the user and provide the state change request by comparing the transaction request to the profile data.

20. The transaction method according to claim 19, wherein the profile data relate to at least one of the following: usage patterns, locations, favourite merchants, transaction amounts, countries and currencies.

21-29. (canceled)
